(19) United States
(12) Patent Application Publication
(10) Pub. No.: US 2003/0174464 A1
(43) Pub. Date: Sep. 18, 2003

(54) Information storage device

(76) Inventors: Takatsugu Funawatari, Miyagi (JP); Yasuyuki Kudo, Miyagi (JP); Masahiro Makino, Miyagi (JP); Chihiro Kikuchi, Miyagi (JP)

Correspondence Address: Robert J. Depke, Holland & Knight LLC, Suite 800, 55 West Monroe Street, Chicago, IL, 60603-5144, US

(21) Appl. No.: 10/364,947

(22) Filed: Feb. 11, 2003

(30) Foreign Application Priority Data
Mar. 14, 2002 (JP) P2002-070823

(51) Int. Cl. G06F 1/16

(52) U.S. Cl. 361/685

(57) ABSTRACT

An information storage device is made freely attachable to and detachable from a main machine via, for example, a cable, by a connector and includes: a hard disk driving mechanism section; and a housing for accommodating the hard disk driving mechanism section therein. The hard disk driving mechanism section is supported and suspended by vibration dampers so as to be spaced apart from the housing. Shock dampers are arranged between the hard disk driving mechanism section and the housing such that, in a normal state, the vibration dampers are in contact only with one of the hard disk driving mechanism section and the housing. Thus, vibration and shock resistance towards externally applied vibration and shock is significantly improved.

### CROSS REFERENCE TO RELATED APPLICATIONS

The present document is based on Japanese Priority Document JP 2002-070823, filed in the Japanese Patent Office on Mar. 14, 2002, the entire contents of which are incorporated herein by reference to the extent permitted by law.

### BACKGROUND OF THE INVENTION

1. Field of the Invention

The present invention relates to an external information storage device, and more particularly to an information storage device having superior vibration and shock resistance.

2. Description of the Related Art

In an information processing apparatus, such as a personal computer or the like, a hard disk drive (HDD) device plays an important role as a recording/reproducing device to or from which data and programs may be recorded or read. Such an HDD is used not only in the main body of an information processing apparatus, but also in external expansion units that are attachable to an information processing apparatus via, for example, a cable as small-sized information storage devices. When detached from an information processing apparatus and not in use, such information storage devices may be carried around by users or they may be stored separate from the information processing apparatus.

### SUMMARY OF THE INVENTION

Once installed in an information processing apparatus, the HDD may be subjected to vibration and/or shock applied thereto via the information processing apparatus, resulting in slower reading/writing. Also, while being carried around as mentioned above, a user may drop the HDD by accident, the impact of which could impair or destroy the HDD. In the external information storage device mentioned above, the HDD is usually housed in a housing. In order to protect the HDD from shock and/or vibration, there are some external information storage devices in which a damper material, such as a sponge, is provided inside the housing. However, a damper material that provides for both high vibration resistance and shock absorbance has not been found, and also, damper materials cannot be attached to fragile parts of the HDD such as the wiring board portion or the center portion of the top cover, which limits the freedom of damper material layout and design. For such reasons, there has not been provided any external information storage device in which the shock and vibration resistance of the HDD is increased significantly.

In order to overcome the above problems, the present invention provides an external information storage device in which the shock and vibration resistance towards vibration and/or shock from outside its housing is greatly improved.

In one embodiment of the information storage device according to the present invention, the information storage device is freely and directly attachable to and detachable from an apparatus via, for example, a cable, and comprises: a hard disk driving mechanism section; a housing for accommodating the hard disk driving mechanism section therein; and a connector section. The hard disk driving mechanism section is supported by a first damper material so as to be spaced apart from the housing. A second damper material is provided between the hard disk driving mechanism section and the housing such that the second damper material contacts, under a normal state, only one of the hard disk driving mechanism section and the housing.

According to this embodiment, two types of damper materials, the first and the second damper materials, are provided, and each is to serve a distinct function of vibration absorption or shock absorption. By using a different damper material for each different purpose to be served, a size, material, and layout that are optimum for each function may be selected. Therefore, according to the present invention, a high level of both vibration and shock absorbance can be achieved simultaneously, to greatly improve both vibration and shock resistance.

In another embodiment of the information storage device according to the present invention, the information storage device is freely and directly attachable to and detachable from an apparatus via, for example, a cable, and comprises: a hard disk driving mechanism section; a first housing for accommodating the hard disk driving mechanism section therein; a second housing for accommodating the first housing therein; and a connector section. The first housing is supported by a first damper material so as to be spaced apart from the second housing.

According to this embodiment, it is the first housing, which accommodates the hard disk driving mechanism section therein, that is supported by the second housing and not the hard disk driving mechanism section itself. Thus, the hard disk driving mechanism section can be supported such that it is spaced apart from the second housing without having any undesirable external force applied to the hard disk driving mechanism section. Therefore, according to the present invention, freedom of layout design of the first damper material is improved, thereby making it easier to optimize the placement of the damper material, and this optimization of the placement of the damper material provides for improved vibration and shock resistance.

Also, a second damper material is provided between the first and the second housings such that the second damper material is in contact with only one of the first and second housings under a normal state.

Each of these first and second damper materials is to serve a distinct function of vibration or shock absorption. By using a different damper material for each different purpose to be served, a size, material, and layout that are optimum for each function may be selected. Therefore, according to the present invention, a higher level of both vibration and shock absorbance can be achieved simultaneously, to further improve vibration and shock resistance.

### BRIEF DESCRIPTION OF THE DRAWINGS

The above and other features and advantages of the present invention will become more apparent from the following description of the presently preferred embodiment of the present invention taken in conjunction with the accompanying drawings, in which:

FIG. 1 is an exploded perspective view of an information storage device according to the present invention;

FIGS. 2A through 2C illustrate the configuration of a hard disk driving mechanism section, wherein FIG. 2A is a perspective view as seen from a top cover side; FIG. 2B is a perspective view as seen from a wiring board side; and FIG. 2C illustrates schematically the internal configuration;

FIG. 3 is a perspective view of the information storage device of FIG. 1 with the upper half of a housing removed;

FIG. 4 is a longitudinal cross section of the information storage device of FIG. 1;

FIG. 5 shows a device for measuring the vibration of an object that is the subject of vibration proofing in order to measure an optimum spring constant;

FIG. 6 is a characteristic graph showing measurements taken by the measuring device;

FIG. 7 is a diagram showing a physical model for representing eigen frequency;

FIG. 8 is a characteristic graph showing a boundary curve which is a reference as to whether an object subjected to some physical impact (shock) will break or not;

FIG. 9 is a characteristic graph showing the relationship between the spring constant and the maximum acceleration an object undergoes when the object is dropped onto a damper material;

FIGS. 10A and 10B are schematic diagrams for illustrating the state of the damper materials inside the housing at the time of shock absorption;

FIG. 11 is a characteristic graph showing the temperature dependency of a gel-like substance and rubber;

FIG. 12 is an exploded perspective view of another information storage device according to the present invention, which has a different configuration;

FIG. 13 is a perspective view of the information storage device of FIG. 12 with the upper half of a housing removed; and

FIG. 14 is a perspective view of a different example of an inner housing of the information storage device of FIG.

### DESCRIPTION OF THE PREFERRED EMBODIMENTS

Preferred embodiments of the present invention will now be described in detail with reference to the accompanying drawings.

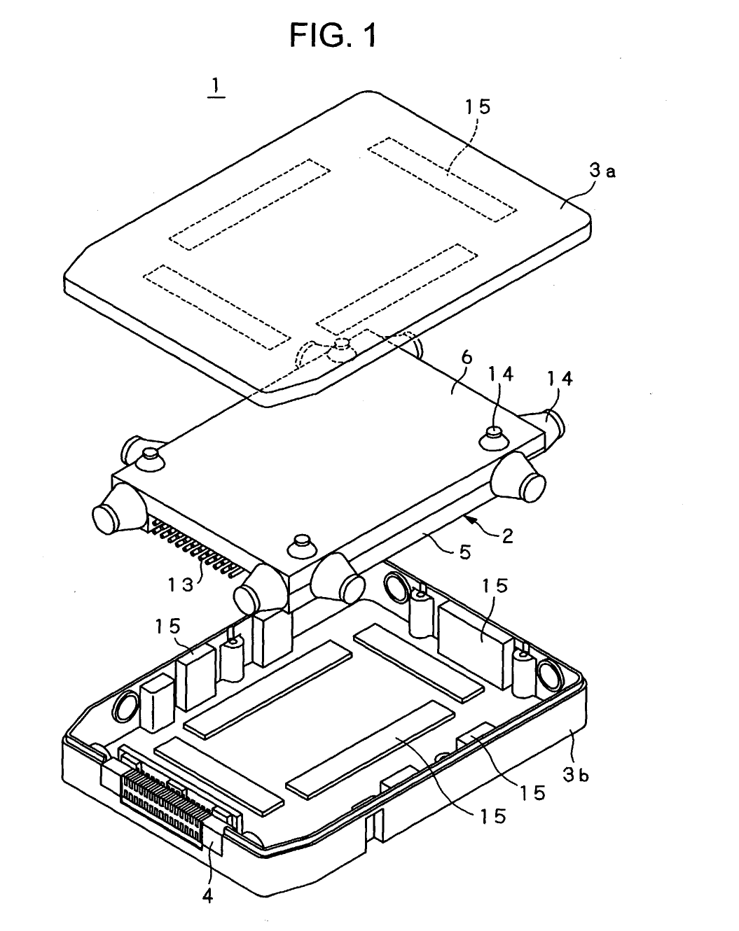

As shown in FIG. 1, an information storage device 1 comprises a hard disk driving mechanism section 2, a housing 3 for accommodating the hard disk driving mechanism section 2 therein, and a connector 4. The information storage device 1 is directly connectable via the connector 4, without a cable, to an electronic equipment, such as a personal computer or a video camera (the electronic equipment to which the information storage device 1 is connectable will hereinafter be referred to simply as “the main apparatus”), as an expansion unit for increasing storage capacity or as a recording medium for storing large quantities of programs and data including images and pictures. The information storage device 1 is freely attachable to and detachable from the main apparatus.

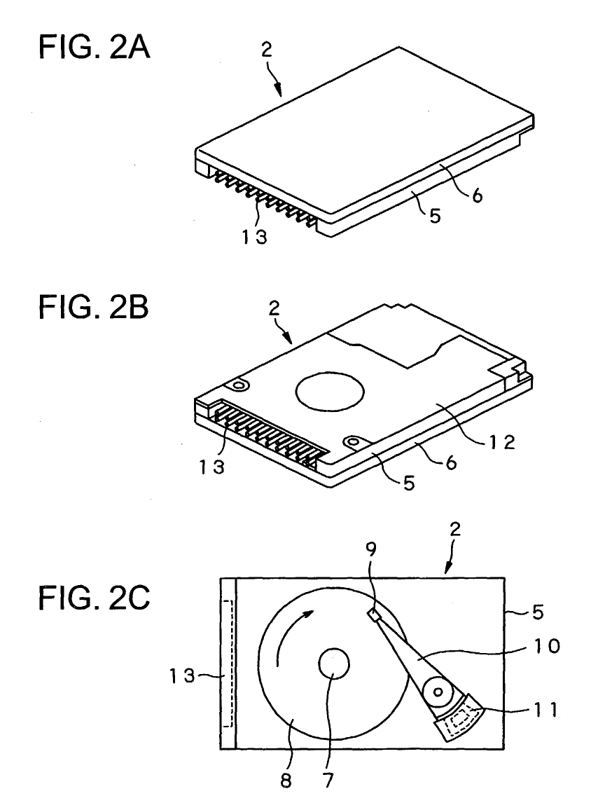

The hard disk driving mechanism section 2 includes a chassis 5 and a top cover 6 (see FIGS. 2A and 2B), and accommodates in a space formed therebetween a magnetic disk 8 mounted on a rotating spindle 7, and a magnetic head 9 supported by an actuator 11 for positioning the magnetic head 9 through a head arm 10 (see FIG. 2C). Also, on the underside of the chassis 5 of the hard disk driving mechanism section 2 is a wiring board 12 that has electronic circuitry provided thereon. The electronic circuitry controls the driving of the various parts mentioned above and the recording/reproducing of information on/from the magnetic disk 8. On the wiring board 12 is a pin connector 13 for inputting/outputting recording/reproduced signals to or from the magnetic head 9 and for supplying power to drive a spindle motor (not shown), the actuator 11, etc. The pin connector 13 is arranged on one side of the chassis 5.

The housing 3 comprises an upper half 3a and a lower half 3b, both of which are formed with a synthetic resin such as plastic. One side wall of the lower half 3b, i.e., one of the short sides thereof in this embodiment, has an opening and the connector 4 is to be inserted in this opening. The pin connector 13 of the hard disk driving mechanism section 2 is connected to the connector 4 through a flexible cable (not shown) having power supply and signal lines. In the information storage device 1, this connector 4 is directly connectable with a connector terminal of the main apparatus, providing an interface for the power supply from the main machine to the hard disk driving mechanism section 2 within the housing 3 and for signal transfer between the main apparatus and the driving mechanism section 2.

As shown in FIGS. 1, 3, and 4, the information storage device 1 is provided with a first damper material for absorbing vibration (hereinafter referred to as “vibration dampers”) 14 and a second damper material for absorbing shock (hereinafter referred to as “shock dampers”) 15, which are provided between the hard disk driving mechanism section 2 and the housing 3 in order to protect the hard disk driving mechanism section 2 from external vibration and impact. The information storage device 1 includes these two types of damper materials between the housing 3 and the hard disk driving mechanism section 2 for the reasons explained below.

For vibration absorption, the eigen frequency of each vibration damper 14 must be reduced to a lower frequency band in order to achieve better vibration protection and to improve the vibration resistance of the information device l. The eigen frequency of the vibration damper 14 is inversely proportional to the square root of the weight of the hard disk driving mechanism section 2, which is the object for which vibration resistance is sought. Hence, the eigen frequency can be lowered to a lower frequency band by making the hard disk driving mechanism section 2 heavier in weight, or by making the proportion of the weight of the hard disk driving mechanism section 2 relative to the vibration damper 14 larger. In practice, however, increasing the weight of the hard disk driving mechanism section 2 results in a heavier information storage device and is neither preferable nor practical. Hence, the eigen frequency of the vibration dampers 14 is reduced by making the vibration dampers 14 smaller in size.

For shock absorption, on the other hand, the shock dampers 15, if too small, would be completely compressed when subjected to an impact from outside the housing 3, and their spring constant would become substantially the same as that of a rigid body. Consequently, too small a shock damper 15 would be useless in that the hard disk driving mechanism section 2 would be subjected to an impact similar to that which would be transmitted if the driving mechanism section 2 was in direct contact with the housing 3. Hence, the shock dampers 15 must be large in size for better shock absorbance and to improve the shock resistance of the information storage device 1.

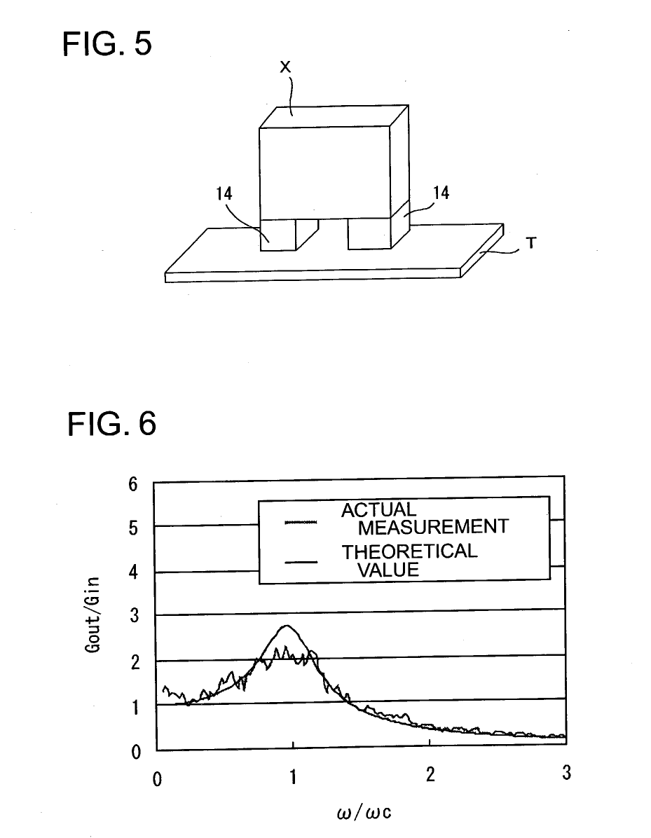

In addition, between a damper material that is used for vibration absorption and a damper material that is used for shock absorption, the optimum spring constant is different. For the present invention, the optimum spring constant for vibration absorption was determined in the following way. As shown in FIG. 5, first, the vibration dampers 14 are placed on a vibrating table T, and an object X to be vibration-proofed is placed on the dampers 14, and then the table T is subjected to vibration while the vibration of the object X is measured. The measurements are shown in FIG. 6.

FIG. 6 is a characteristic graph, in which vibration is represented as being nondimensional, and the vertical axis represents the ratio of the acceleration of the object X (output acceleration amplitude Gout) to the input acceleration of the vibrating table T (input acceleration amplitude Gin) and the horizontal axis represents the ratio of the vibration frequency (input frequency ω) to the primary eigen frequency of the vibration damper 14 (eigen frequency ωc). As can be seen from this diagram, when the vibration frequency is lower than the eigen frequency, the ratio of Gout/Gin 1. And as the vibration frequency approaches the eigen frequency, in other words, as the value along the horizontal axis approaches 1, the Gout/Gin ratio becomes higher, and it reaches a peak value when the vibration frequency equals the eigen frequency, or in other words, at a point where the value along the horizontal axis becomes 1. Then, as the vibration frequency becomes larger than the eigen frequency, the Gout/Gin ratio decreases. This phenomenon generally applies to all typical vibration dampers, and vibration damping effects can be achieved only when the Gout/Gin ratio is 1 or below. This teaches that the eigen frequency ωc of the vibration damper 14 should be made as low as possible to lower the frequency at which ω=ωc in order to obtain vibration damping effects over a wider range of vibration frequencies.

The eigen frequency ωc can be expressed by Eq. (1) in a physical model in which a weight (the object X) has a mass m and the vibration damper 14 has a spring constant k. [Eq. 1]

$${ω}_{c} = \sqrt{\frac{k}{m}} \qquad Eq . ( 1 )$$

From Eq. (1), it can be seen that the eigen frequency ωc becomes smaller the smaller the spring constant k is, and therefore, that vibration damping effects can be achieved with the vibration damper 14 over a wider frequency range the smaller its spring constant k is.

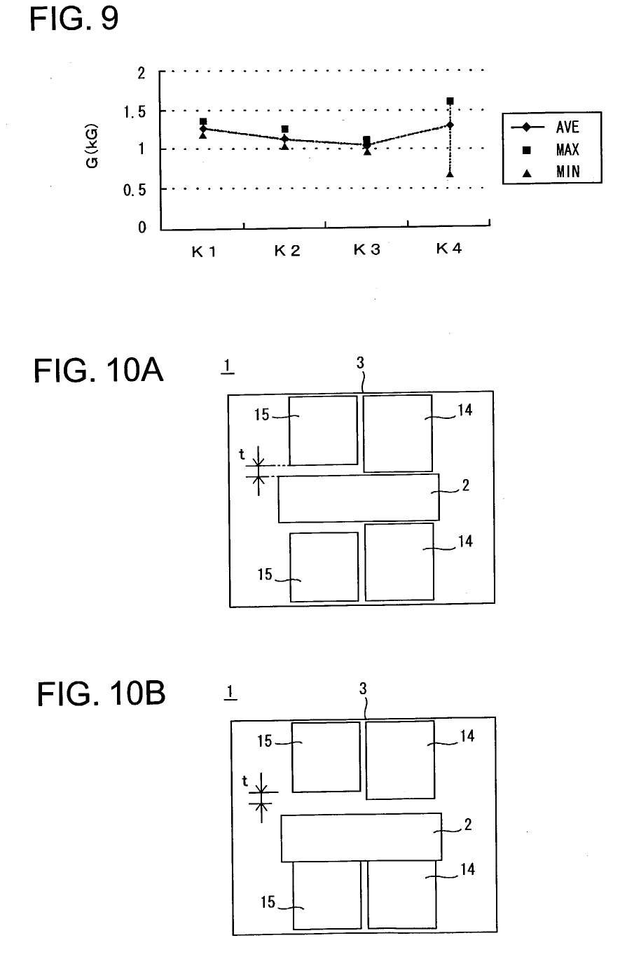

For impact absorption, on the other hand, a boundary curve, which can be used as a criteria as to whether an object will break or not when it is subjected to some impact, was used to determine the optimum spring constant. In the boundary curve shown in FIG. 8, the horizontal axis represents the velocity change an object undergoes, and the vertical axis represents the acceleration the object undergoes at impact. The area marked by region A in FIG. 9 indicates the range of velocity change and acceleration at impact in which the object would break. As can be seen from the figure, in order to prevent breakage, the velocity change and acceleration from the impact must be kept within regions B in the same figure. More specifically, velocity change or acceleration must be decreased.

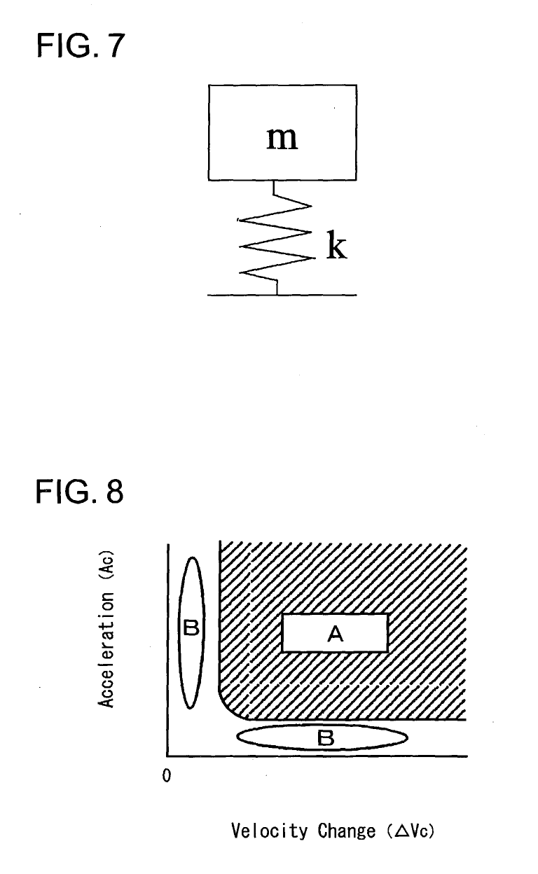

Generally, many shock damper materials utilize their damping effect to reduce impact acceleration that an object undergoes, thereby protecting the object from breakage. For this reason, to achieve greater shock absorbing effects, the spring constant k of the shock damper 15 at which acceleration is minimized in the physical model (FIG. 7) for the vibration damper 14 becomes an issue. FIG. 9 shows a characteristic graph in which a plurality of spring constants k (k1-k4) are plotted on the horizontal axis and the vertical axis represents the maximum acceleration an object undergoes when the object is dropped onto each of several shock dampers having one of the spring constants k1 to k4. In the case of the shock damper 15 with the smallest spring constant k1, the shock damper 15 is too soft and is completely compressed from the impact experienced, thus resulting in a large maximum acceleration. Conversely, in the case of the shock damper 15 with the largest spring constant k4, the shock damper 15 is too rigid, has little or no damping effect, and results in a large maximum acceleration. As can be understood from FIG. 9, there exists between the smallest spring constant k1 and the largest spring constant k4 the optimum k that minimizes acceleration, which in this figure is the spring constant k3. The shock damper having this spring constant k3 can provide the best shock absorption effect.

For reasons explained above, between a vibration damper and a shock damper, the spring constant and the size of the damper material that are most effective are different, and it is difficult to simultaneously achieve superior vibration damping and shock absorption in one damper material. Thus, in the information storage device 1, two types of dampers, the vibration dampers 14 suited for vibration absorption and the shock dampers 15 suited for impact absorption, each of which has a different spring constant and size, are provided inside the housing 3. Thus, by providing distinct damper materials for vibration absorption and shock absorption in the information storage device 1, both a damper material having an ideal spring constant and size for vibration absorption as well as another damper material that has an ideal spring constant and size for shock absorption can be selected and used, thereby achieving higher effects in each of vibration and shock absorbance, and improving vibration and shock resistance.

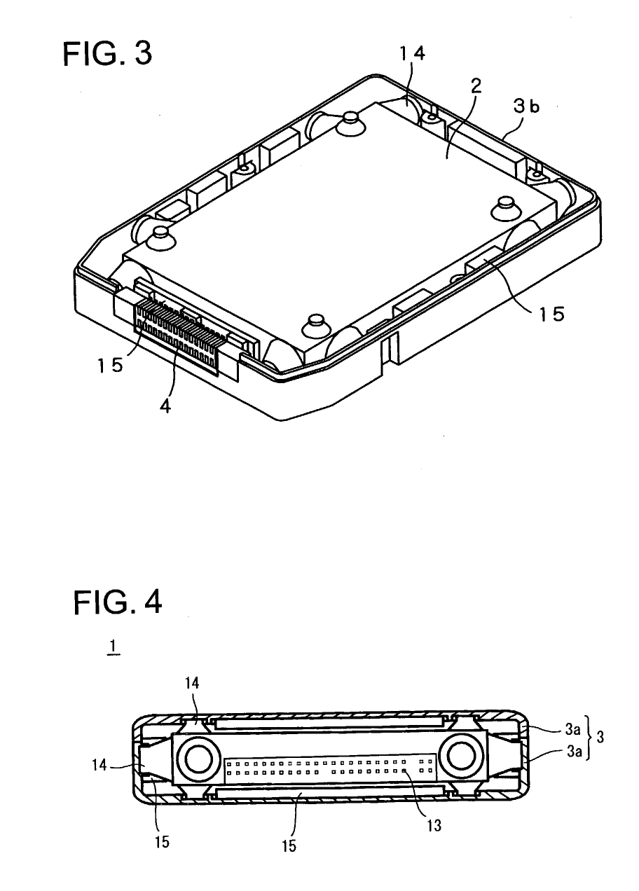

As shown in FIGS. 3 and 4, the vibration dampers 14 have a truncated and substantially conical shape and are arranged between the hard disk driving mechanism section 2 and the housing 3 such that the end thereof having a smaller diameter is in contact with the housing 3, and the end thereof having a larger diameter is in contact with the hard disk driving mechanism section 2. These vibration dampers 14 are provided on all surfaces of the hard disk driving mechanism section 2, in other words, the upper surface of the top cover 6, the lower surface of the wiring board 12, and four side walls adjacent thereto. On each of the upper and lower surfaces, four vibration dampers 14 are arranged close to the four corners thereof, and on each of the side walls, two vibration dampers 14 are arranged at both ends thereof. Thus, in the information storage device 1, the hard disk driving mechanism section 2 is supported and suspended by a plurality of vibration dampers 14 so as to be spaced apart from the housing 3.

The shock dampers 15 are provided in a space between the housing 3 and the hard disk driving mechanism section 2 that is supported and suspended by the vibration dampers 14 and thus spaced apart from the housing 3. The shock dampers 15 are provided such that they are in contact with only one of the hard disk driving mechanism section 2 and the housing 3 when the information storage device 1 is at rest with neither vibration nor shock applied thereto (normal state). In this embodiment, the shock dampers 15 are disposed such that they are in contact only with the housing 3 and are spaced away from the hard disk driving mechanism section 2 by a given distance. However, these shock absorbers 15 may also be arranged so as to be in contact only with the hard disk driving mechanism section 2 and spaced apart from the housing 3 by a given distance.

Each of the shock dampers 15 has a shape resembling a flat plate and is larger in volume than each of the vibration dampers 14, and, as will be described below, when the information storage device 1 is subjected to some impact, the contact surface area between the hard disk driving mechanism section 2 and the shock damper 15 is larger than the contact surface area between the hard disk driving mechanism 2 and the vibration dampers 14. These shock dampers 15 are provided at positions facing the surfaces of the hard disk driving mechanism section 2. For example, with respect to the upper and lower surfaces of the hard disk driving mechanism section 2, these shock dampers 15 are provided on surfaces of the housing 3 that face the upper and lower surfaces of the hard disk driving mechanism section 2, and with respect to each of the side walls of the hard disk driving mechanism section 2, at least one shock damper 15 is provided on a surface of the housing 3 facing the side wall of the hard disk driving mechanism section 2 and at a position opposite approximately the center portion of the side wall of the hard disk driving mechanism section 2. Because the same material is used for both types of dampers 14 and 15 in this embodiment, the contact surface area between the shock damper 15 and the hard disk driving mechanism section 2 is larger as compared to the contact surface area between the vibration damper 14 and the hard disk driving mechanism section 2. However, if the vibration and shock dampers 14 and 15 are made of different kinds of materials, then the contact surface areas in question may not have the same relationship as described above, and the contact surface areas may change as are ideal in relation to the materials employed.

Referring now to FIGS. 10A and 10B, it will now be explained how shock absorption works in the information storage device 1 in which the vibration dampers 14 and the shock dampers 15 are arranged as described above. FIG. 10A shows a positional relationship among the hard disk driving mechanism section 2, the housing 3, the vibration dampers 14, and the shock dampers 15 under static conditions, i.e., for example, under a condition where the information storage device 1 is set up some place and only weak vibration is being applied. Under this static condition, since only the vibration dampers 14 are in contact with the hard disk driving mechanism section 2 to provide damping effects, a high level of vibration damping can be achieved.

By contrast, when, for example, the information storage device 1 is dropped and is subjected to shock, in other words, under dynamic conditions, one or more of the vibration dampers 14 is contracted by an amount equal to or exceeding the gap t between the shock damper 15 and the hard disk driving mechanism section 2, thereby bringing the hard disk driving mechanism section 2 into contact with one of the shock dampers 15, as shown in FIG. 10B. As a result, now the shock damper 15 provides damping effects, adequately reduces the acceleration the hard disk driving mechanism section 2 undergoes, and high impact absorption effects can be achieved. Once an adequate period of time elapses after the impact, the interior of the housing 3 returns to a static state, i.e., the shock dampers 15 are spaced apart from the hard disk driving mechanism section 2, and only the vibration dampers 14 are absorbing vibration.

In the information storage device 1 according to this embodiment, the two types of dampers 14 and 15 are arranged to work as described above in all directions, including lengthwise, widthwise, and thicknesswise directions, to support and suspend the hard disk driving mechanism section 2 so as to be spaced apart from the housing 3. Hence, a high level of vibration and shock absorption can be achieved in all the three space dimensions, and the vibration and shock resistance of the information storage device 1 can be improved.

For the vibration dampers 14, a member having elasticity, for example, viscoelastic bodies such as rubber or gel-like substances, and springs or the like, may be used. Rubbers which may be used include natural rubber (NR), isoprene rubber (IR), styrene butadiene rubber (SBR), butyl rubber (IIR), butadiene rubber (BR), nitrile rubber (NBR), silicone rubber, and fluoro rubber, and specific examples would include, HANENITE (brand name) manufactured by Naigai Rubber Industry Co., Ltd., PORON (brand name) manufactured by Inoac Corporation, and the like. For the gel-like substance, gel-like materials that contain silicone as the main ingredient, such as silicone gels may be used, specific examples of which include αGEL®, βGEL, and θGEL (all brand names) manufactured by GELTEC Co., Ltd. and the like. For the spring, metallic springs, such as coil springs or plate springs, may be used.

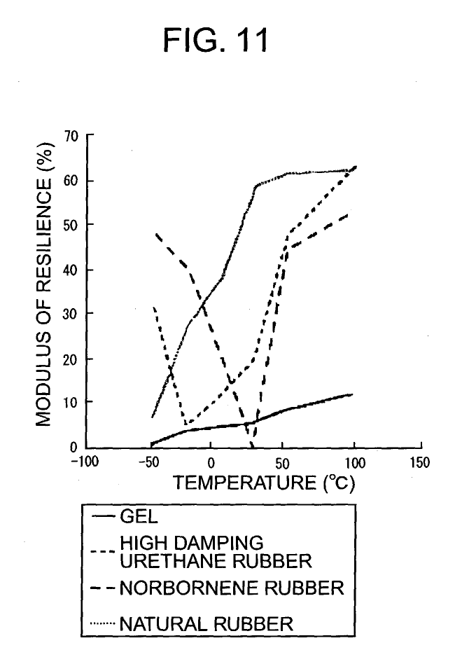

As shown in FIG. 11, in general, the moduli of resilience of rubbers change drastically with temperature due to their temperature dependent properties. Rubbers also become stiff at about −10° C. and their vibration absorbing capabilities become impaired. In contrast, gel-like substances exhibit substantially stable mechanical properties (Young's modulus, which is interchangeable with “softness”) between −50° C. and 200° C., and thus could maintain good vibration characteristics under various environments including outdoors in a cold district or under direct exposure to sunlight on a hot day, for example. Also, rubbers have a high compression set (or compressive residual stress), and when a load is applied over an extended period, theymay, in some cases, become too fatigued and thus unable to maintain good vibration characteristics. In contrast, gel-like substances have low compressive residual stress, and therefore can maintain good vibration characteristics over a longer period of time. In addition, rubbers have inferior vibration-absorbing capabilities in low frequency bands as compared to gel-like substances of the same form. For these reasons, it is preferable to use a gel-like substance for the vibration dampers 14. It is particularly preferable to use a silicone gel whose damping effects are less prone to changes even in the event of wide ranging temperature changes. In this embodiment, silicone gel was used for the vibration dampers 14.

The shock dampers 15 need only have moderate softness and be able to reduce acceleration. Basically, a member similar to that used for the vibration dampers 14, such as a member having elasticity including, for example, viscoelastic bodies such as rubber or gel-like substances, springs and the like may be used. Since materials that are less temperature-dependent and have stable properties are more suited for the shock dampers 15, gel-like substances are preferable to rubbers. It is particularly preferable to use a silicone gel, which exhibits stable shock absorbing effects over a wide range of temperatures. In this embodiment, silicone gel was used for the shock dampers 15.

Although in the present embodiment silicone gel is used for the vibration dampers 14 and the shock dampers 15, the present invention is by no means limited thereto, and the dampers 14 and 15 may both be made of rubber, or a combination of different kinds of elastic members or materials, such as rubber and gel, gel and a metallic spring, or the like may also be adopted. When different kinds of materials are used between the vibration dampers 14 and the shock dampers 15, the vibration dampers 14 and the shock dampers 15 are formed in such a manner that the respective contact surface areas with the hard disk driving mechanism section 2 would be appropriate in relation to the materials used.

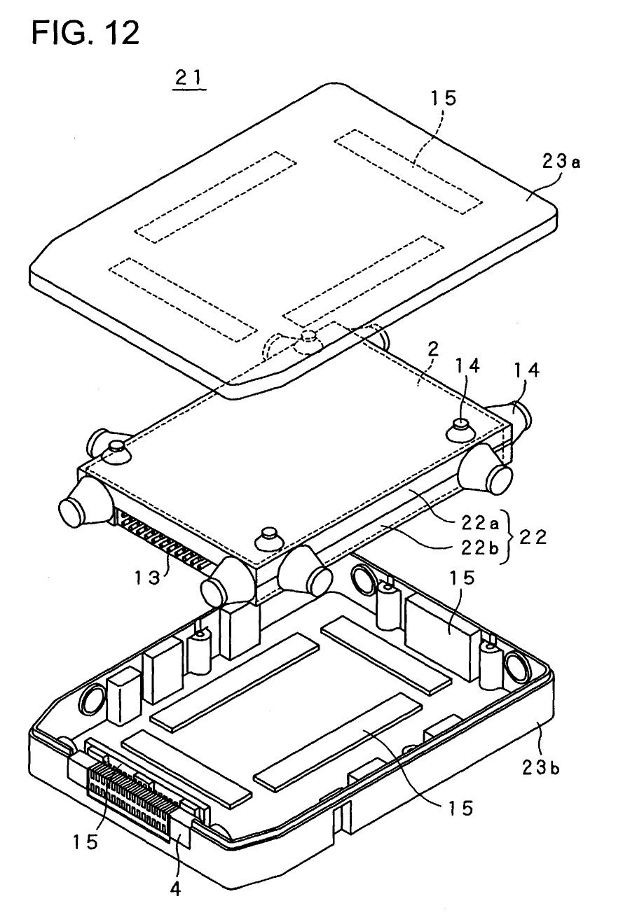

Referring next to FIG. 12, an information storage device 21 according to another embodiment of the present invention will be described. In the following description, like parts and components are given the same reference numerals, and detailed descriptions thereof will be omitted.

The information storage device 21 according to another embodiment comprises a hard disk driving mechanism section 2, an inner housing 22 for accommodating the hard disk driving mechanism section 2 therein, and an outer housing 23 for accommodating the inner housing 22 therein. The information storage device 21 has a double housing structure in which the hard disk driving mechanism section 2 is protected by the inner and outer housings 22 and 23.

The hard disk driving mechanism section 2 is of a similar construction to that for the information storage device 1 mentioned earlier. That is, the hard disk driving mechanism section 2 includes, although not shown in FIG. 12, a chassis 5 and a top cover 6, and accommodates in a space formed therebetween a magnetic disk 8 mounted on a rotating spindle, and a head positioning actuator that supports a magnetic head, which records and reproduces information on and from the magnetic disk, through a head arm 10. Also, on the underside of the chassis 5 of this hard disk driving mechanism section 2 is a wiring board that has electronic circuitry provided thereon. The electronic circuitry controls the driving of the above parts and controls the recording/reproduce of information on/from the magnetic disk 8. On the wiring board is a pin connector 13 for inputting/outputting recording/reproduced signals to/from the magnetic head and for supplying power to drive a spindle motor, the actuator, etc. The connector 13 is arranged such that it faces outward from one of the sides of the chassis 5.

The inner housing 22 accommodates the hard disk driving mechanism section 2 therein, and comprises an upper half 22a and a lower half 22b. One side wall of the lower half 22b, i.e., one of the short sides thereof in this embodiment, has an opening, and the connector 13 provided on the hard disk driving mechanism section 2 is exposed through this opening.

The inner housing 22 should preferably be made of a strong and lightweight metal such as aluminum or magnesium, but it may, of course, also be made of general-purpose and relatively strong synthetic resins including polycarbonates and ABS resins, or fiber-reinforced plastic having both carbon and glass fibers mixed with the synthetic resins above.

The inner housing 22 has a closed structure in which the upper and lower halves 22a and 22b are sealed with, for example, a gasket. In the information storage device 21, this closed structure of the inner housing 22 allows the air pressure surrounding the hard disk driving mechanism section 2 housed therein to be kept fixed. In the hard disk driving mechanism section 2, the magnetic head floats ten-some nanometers to several tens of nanometers while the magnetic disk 8 is rotating.

This floating decreases in proportion to the decrease in the surrounding air pressure. As the amount by which the magnetic head floats becomes smaller, it becomes more likely that the magnetic head contacts the surface of the magnetic disk 8, interfering with the reading/writing of information and, hence, there lies a problem in that it could lead to increased errors during recording/reproduction. It is thus desirable that the air pressure around the hard disk driving mechanism section 2 be constant in any environment in order to maintain the reliability of the information storage device. In the information storage device 21, by adopting a closed structure, as mentioned above, for the inner housing 22 and thus keeping the air pressure surrounding the hard disk driving mechanism section 2 constant, the hard disk driving mechanism section 2 can be operated properly even in environments of low air pressure, for example, at highlands such as a mountaintop, thus remarkably improving the reliability of the device itself. Additionally, because the effects of pressure changes on the hard disk driving mechanism section 2 are eliminated, the accuracy with which the mechanical parts are assembled can be maintained.

Furthermore, in certain situations, the information storage device 21 may experience some loss of recorded data due to the surface of the magnetic disk 8 being corroded by adhesion of corrosive gases such as H₂S, NO₂, Cl₂, SO₂ and the like, or some trouble in data recording/reproduction due to deposition of ions such as Li, Na, K, and Ca ions and the like on the magnetic disk 8. This is attributable to the fact that the magnetic head floats, as mentioned above, by as small an amount as several tens of nanometers. Therefore, a structure in which entry of gases and ions into the interior of the hard disk driving mechanism section 2 is prevented as much as possible is desirable. To this end, the hard disk driving mechanism section 2 is provided with a respiratory filter such that only air having passed therethrough enters the interior of the hard disk driving mechanism section 2. However, this respiratory filter is intended mainly for home and office use, and does not serve as a heavy-duty gas filter. Hence, when the information storage device 21 is used in a special environment, such as at a hot spring or spa, for example, sulfuric components are likely to enter the hard disk driving mechanism section 2. In the information storage device 21, the inner housing 22 has a closed structure as mentioned above, and this structure can keep the air pressure surrounding the hard disk driving mechanism section 2 constant, to completely block entry of outside air into the inner housing 22, thereby preventing the deposition of corrosive gases and ions on the magnetic disk and hence significantly improving the reliability of the device itself.

The outer housing 23 comprises an upper half 23a and a lower half 23b, and is similar in construction to the housing 3 of the previously mentioned information storage device 1. The outer housing 23 is made of a synthetic resin such as plastic, and its lower half 23b has an opening in one side wall thereof, and a connector 4 is attached to this opening. The pin connector 13 of the hard disk driving mechanism section 2 exposed through the opening formed in the inner housing 22 is connected to the connector 4 via a flexible cable (not shown).

It should be appreciated that by forming the inner housing 22 of the information storage device 21 with a light metal such as aluminum or magnesium, the seal of the inner housing 22 can be further enhanced.

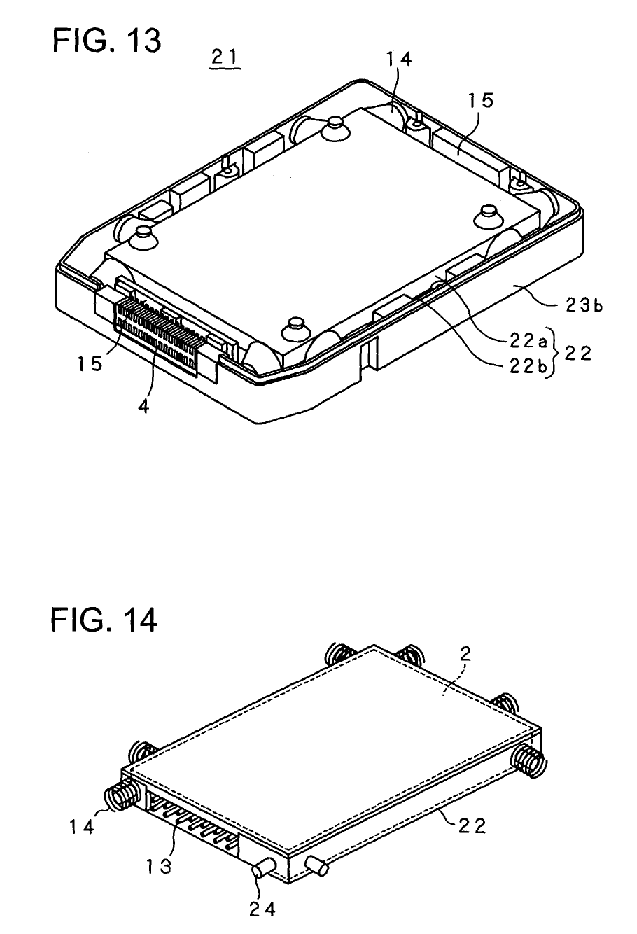

As shown in FIG. 13, the information storage device 21 has vibration dampers 14 and shock dampers 15 interposed between the inner and outer housings 22 and 23. The vibration dampers 14 support and suspend the inner housing 22 such that the inner housing 22 is spaced part from the outer housing 23. For these vibration dampers 14, an elastic member including, for example, viscoelastic bodies, such as rubber or gel-like substances, springs and the like may be used. Particularly preferable is a silicone gel, which is used for the vibration dampers 14 in this embodiment.

In supporting the hard disk driving mechanism 2 directly with the vibration dampers 14 as in the information storage device 1, there are appropriate positions and inappropriate positions on the hard disk driving mechanism 2 for the vibration dampers 14 to contact. Appropriate positions for the vibration dampers 14 to contact would include hard portions that do not deform under stress, such as the chassis 5, and inappropriate positions would include soft portions, such as the wiring board or around the middle of the top cover 6, for example. If the vibration dampers 14 are placed in contact with these inappropriate positions to support the hard disk driving mechanism section 2, if the top cover 6 of the hard disk driving mechanism section 2 is subjected to some impact, the cover 6 would become deformed, and this may, in certain situations, lead to some trouble such as the disk inside the hard disk driving mechanism section 2 becoming unable to rotate, and may further develop into a fatal defect where important information recorded on the disk cannot be read. Moreover, if the wiring board of the hard disk driving mechanism section 2 is subjected to some impact, ICs and memories on the wiring board could fall off or become unsoldered to cause defective contacts, and could cause situations in which recording/reproduction is no longer possible.

However, in the information storage device 21, the hard disk driving mechanism section 2 is accommodated in the inner housing 22 and it is the inner housing 22, not the hard disk driving mechanism section 2 itself, that is supported by the vibration dampers 14 in the outer housing 23. The inner housing 22 is rigid as it is made of a material such as a light metal or a synthetic resin as mentioned above, and regardless of the position of the vibration dampers 14, the inner housing 22 can be supported by the vibration dampers 14 relative to the outer housing 23 while protecting the hard disk driving mechanism section 2 from any undesirable external force. This provides the information storage device 21 with more freedom in designing the layout of the vibration dampers 14, making it easier to optimize the layout of the damper materials. By optimizing the arrangement of the damper materials, the information storage device 21 can improve its shock and vibration resistance.

In the information storage device 21, the hard disk driving mechanism section 2 is accommodated in the inner housing 22, thereby making it easier to use coil springs as the vibration dampers 14. Specifically, as shown in FIG. 14, by providing projections 24 on the inner housing 22 for positioning coil springs, it becomes possible to attach the coil springs which function as the vibration dampers 14 easily and reliably. These coil springs, which are metal springs, exhibit stable damping characteristics over time due to their exceptional resistance against permanent deformation. In addition, despite their stable quality, coil springs are extremely cheap, and further by providing the projections 24, the ease of assembly can be improved. Hence,in the information storage device 21, because attaching coil springs is made easy with the inner housing 22, there is more freedom not only in the layout of the vibration dampers 14 but also in the choices of members or materials for use as the dampers, thereby improving vibration and shock resistance. If providing the positioning projections 24 for the coil springs on the inner housing 22, recesses for receiving the coil springs may also be provided at locations of the inner side walls of the outer housing 23 corresponding to the projections 24, or alternatively, only the recesses may be formed in the outer housing 23 as positioning portions for the coil springs.

The shock dampers 15 are arranged between the outer housing 23 and the inner housing 22 that is supported and suspended by the vibration dampers 14 so as to be spaced apart from the outer housing 23. The shock dampers 15 are arranged such that they are in contact only with one of the inner housing 22 and the outer housing 23 under a normal state. In this embodiment, the shock dampers 15 are arranged so as to be in contact only with the outer housing 23 in a normal state. For these shock dampers 15, an elastic member including, for example, viscoelastic bodies such as rubber or gel-like substances, metal springs and the like may be used as in the vibration dampers 14. In this embodiment in which it is particularly preferable to use a silicone gel, the shock dampers 15 are made of a silicone gel. As was possible for the information recording device 1, in this embodiment, too, the shock dampers 15 may be arranged so as to be in contact only with the inner housing 22 and spaced apart from the outer housing 23. Rubber and/or gel-like substances, when used as the vibration and shock dampers 14 and 15, may produce various gases that are harmful to the magnetic disk 8. However, by having the hard disk driving mechanism section 2 accommodated in the completely closed inner housing 22 as mentioned earlier, these gases are prevented from depositing on the disk surface in the hard disk driving mechanism section 2, and problems with data recording/reproduction can thereby be prevented.

As mentioned earlier, by providing the damper material for vibration absorption and the damper material for shock absorption separately, the information storage device 21 is able to select for each type of damper material the optimum size and spring constant for each function of vibration absorption or shock absorption, achieve high vibration and shock absorption effects, and hence improve vibration and shock resistance. Additionally, by forming the inner housing 22 of the information storage device 21 with a fiber-reinforced plastic, or with a light metal such as aluminum or magnesium, a higher level of vibration and shock absorbance can be expected, and the vibration and shock resistance can be improved.

Furthermore, while being highly vibration and shock resistant, the information storage device 21 also has its hard disk driving mechanism section 2 accommodated in the inner housing 22 that has a closed structure, and is capable of having the hard disk driving mechanism section 2 operate properly even in special environments including low-pressure highlands such as a mountaintop and hot spring resorts where the atmosphere contains ions. Therefore, the information storage device 21 is suitable for use as a storage medium for electronic devices expected to be used in various environments. For example, the information storage device 21 could be used as a storage medium for storing image data shot with a video camera, which may very well be used at highlands, hot springs, and the like.

Thus, since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

What is claimed is:

1. An information storage device that is freely attachable to and detachable from a main machine, said information storage device comprising:
a hard disk driving mechanism section;
a housing for accommodating said hard disk driving mechanism section therein;
a connector section;
at least one first damper; and
at least one second damper,
wherein said hard disk driving mechanism section is supported and suspended by said at least one first damper so as to be spaced apart from said housing, and
said at least one second damper is arranged between said hard disk driving mechanism section and said housing and, in a normal state, is in contact only with one of said hard disk driving mechanism section and said housing.

2. The information storage device according to claim 1, wherein each of said first and second dampers comprises an elastic member.

3. The device according to claim 2, wherein said elastic member comprises a gel-like substance.

4. The device according to claim 3, wherein said gel-like substance comprises a silicone gel.

5. An information storage device that is freely attachable to and detachable from a main machine, said information storage device comprising:
a hard disk driving mechanism section;
a first housing for accommodating said hard disk driving mechanism section therein;
a second housing for accommodating said first housing therein;
a connector section; and
at least one first damper,
wherein said first housing is supported and suspended by said at least one first damper so as to be spaced apart from said second housing.

6. The information storage device according to claim 5, further comprising at least one second damper, wherein said at least one second damper is arranged between said first and second housings and, in a normal state, is in contact only with one of said first and second housings.

7. The information storage device according to claim 5, wherein said first housing comprises a light metal.

8. The information storage device according to claim 6, wherein each of said first and second dampers comprises an elastic member.

9. The information storage device according to claim 8, wherein said elastic member comprises a gel-like substance.

10. The information storage device according to claim 9, wherein said gel-like substance comprises a silicone gel.

11. The information storage device according to claim 8, wherein said at least one first damper comprises a coil spring.

12. The information storage device according to claim 11, wherein said second housing comprises a positioning section for said coil spring.

13. The information storage device according to claim 11, wherein said first housing comprises a positioning section for said coil spring.
